(19) United States
(12) Patent Application Publication
(10) Pub. No.: US 2007/0147600 A1
(43) Pub. Date: Jun. 28, 2007

(54) Multiple call origination

(75) Inventors: Daniel Stahlman, Apex, NC (US); Stephen Sorice, Raleigh, NC (US); Vasudevan Krishnamurthy, Durham, NC (US); Paresh Mehta, Cary, NC (US); James King JR., Durham, NC (US)

Correspondence Address: WITHROW & TERRANOVA, P.L.L.C., 100 REGENCY FOREST DRIVE, SUITE 160, CARY, NC, 27518, US

(73) Assignee: NORTEL NETWORKS LIMITED, St. Laurent (CA)

(21) Appl. No.: 11/316,061

(22) Filed: Dec. 22, 2005

(51) Int. Cl. H04M 3/00; H04M 5/00

(52) U.S. Cl. 379/266.07

(57) ABSTRACT

The present invention allows originating equipment in a telephony network to originate multiple calls on behalf of a single user in response to a single user event. A user will provide multiple call indicia, perhaps in the form of a string of dialed digits, and a multiple call origination function located in the originating terminal, originating node supporting the originating terminal, or associated service node, will respond to the multiple call indicia as follows. Based on the multiple call indicia, multiple destinations associated with the multiple call indicia are identified. Multiple calls are initiated to the multiple destinations in a simultaneous or sequential fashion. A telephony connection for the call is established from the originating terminal to the first one of the multiple destinations to answer a call initiation attempt. If any other call initiation attempts are still in progress, they are stopped upon one of the destinations being answered.

### FIELD OF THE INVENTION

The present invention relates to telecommunications, and in particular to originating multiple calls from a single dialing event.

### BACKGROUND OF THE INVENTION

In modern society, people often have numerous telephony terminals including mobile, home, and office telephones. With the evolution of voice-over-packet communications, more people are adding personal computers, personal digital assistants, and other packet telephony devices to their growing list of telephony terminals. As such, many people have at least three telephony addresses in the form of directory numbers and uniform resource identifiers. As people move around throughout the day, callers are often faced with the frustrating task of sequentially calling multiple telephony addresses in an effort to contact someone. For example, a caller may make futile attempts to call another party at work and home prior to a successful attempt using the party's mobile telephony number.

In an effort to address these issues, terminating equipment associated with the called party has been configured to direct incoming calls to one or more of the called party's telephony addresses. The terminating equipment can be configured to have multiple ones of the called party's telephony terminals to ring at once or in sequence. The call is connected to the first telephony terminal answered. Unfortunately, there is little terminating equipment configured as such. When such equipment is available, the parties associated with it often do not take the time to configure the equipment to provide the available functionality, perhaps because the called party is not the party inconvenienced by having to make several calls. Accordingly, there is a need for a more efficient and effective technique to eliminate the inconvenience associated with having to make several calls to different telephony addresses in an effort to contact a given person. There is a further need to shift control of the call technique to the caller, who is the one benefiting most from the added convenience.

### SUMMARY OF THE INVENTION

The present invention allows originating equipment in a telephony network to originate multiple calls on behalf of a single user in response to a single user event. A user will provide multiple call indicia, perhaps in the form of a string of dialed digits, and a multiple call origination function located in the originating terminal, an originating node supporting the originating terminal, or an associated service node, will respond to the multiple call indicia as follows. Based on the multiple call indicia, multiple destinations associated with the multiple call indicia are identified. Multiple calls are initiated to the multiple destinations in a simultaneous or sequential fashion. A telephony connection for the call is established from the originating terminal to the first one of the multiple destinations to answer a call initiation attempt. If any other call initiation attempts are still in progress, they are stopped upon one of the destinations being answered.

The call initiation attempts to the multiple destinations may take place simultaneously, wherein calls are initiated in a substantially simultaneous fashion to each of the multiple destinations associated with the multiple call indicia. As such, terminating terminals at the various destinations may ring or provide appropriate alerts for an incoming call until one of the terminating terminals is answered. When a terminating terminal is answered, steps are taken to halt the other call initiation attempts.

Calls to the multiple destinations associated with the multiple call indicia may be initiated in sequence. As such, a first call is initiated wherein a caller is given a certain amount of time or number of rings to answer the terminating terminal at the first destination. If the call initiation attempt goes unanswered, a subsequent call is initiated to the next destination, and the process repeats until a call initiation attempt is answered, or until call initiation attempts have been made to each of the destinations associated with the multiple call indicia.

The concepts of the present invention may be applied to the public switched telephone network (PSTN), packet networks, cellular networks, and the like. Access to these networks may be provided through wired or wireless techniques. With the present invention, an originating entity, which is the originating terminal or closely associated with the originating terminal, is able to allow the user to define a list of destinations associated with select multiple call indicia. When the multiple call indicia is provided by the user, sequential or simultaneous calls may be initiated to the respective destinations in an automated fashion. As such, the need for the user to manually initiate multiple calls to track down a called party is avoided.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a communication environment according to one embodiment of the present invention.

FIG. 2 is a flow diagram illustrating operation of an originating node according to one embodiment of the present invention.

FIG. 3A is communication flow illustrating simultaneous call initiation in response to a multiple call event according to one embodiment of the present invention.

FIG. 3B is communication flow illustrating sequential call initiation in response to a multiple call event according to one embodiment of the present invention.

FIG. 4 illustrates multiple call initiation from an originating proxy in a Session Initiation Protocol environment.

FIG. 5 illustrates multiple call initiation from an originating terminal in a Session Initiation Protocol environment.

FIG. 6 illustrates multiple call initiation from a service node in a Session Initiation Protocol environment.

FIG. 7 illustrates multiple call initiation from a switch in a public switched telephone network.

FIG. 8 illustrates multiple call initiation from a service node in a public switched telephone network.

FIG. 9 is a block representation of an originating terminal according to one embodiment of the present invention.

FIG. 10 is a block representation of an originating node according to one embodiment of the present invention.

FIG. 11 is a block representation of a service node according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention originates multiple calls to different telephony addresses in response to a multiple call event triggered by the caller. An originating node or function associated with the caller's originating terminal will recognize the multiple call event, identify multiple telephony addresses associated with the multiple call event, and initiate multiple calls to the identified telephony addresses. A telephony connection is established for the first call that is answered. The calls may be initiated at the same time or one after another until one of the calls is answered. Once a call is answered and a telephony connection for the call is established, other call initiation attempts are halted.

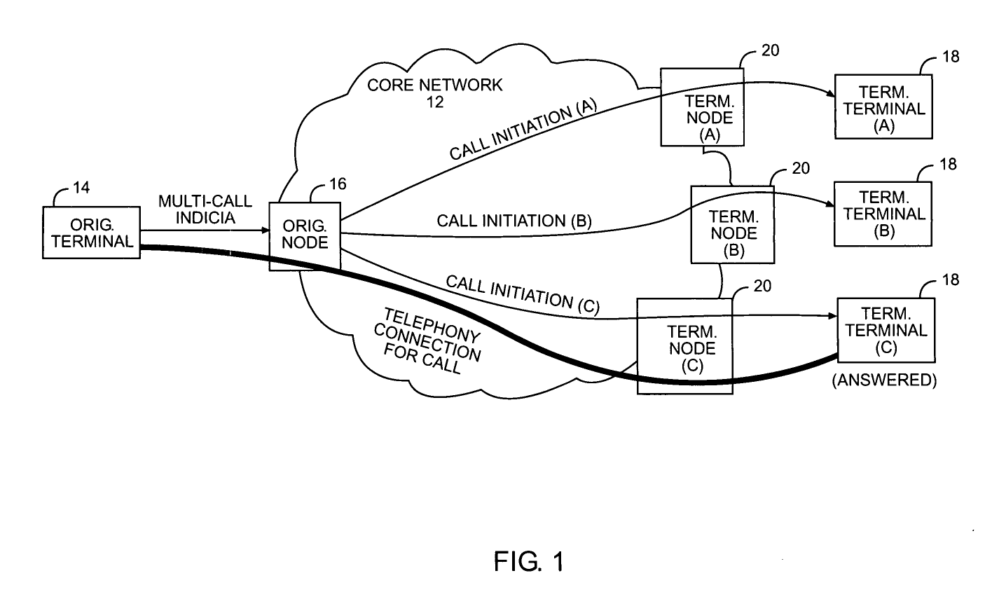

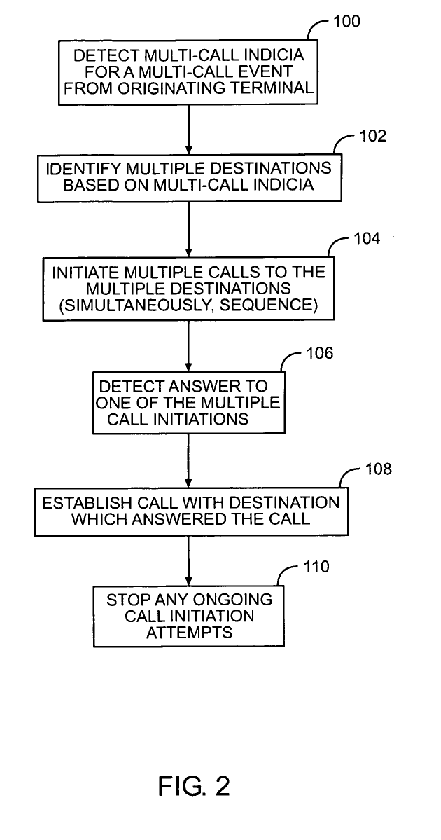

With reference to FIGS. 1 and 2, a block representation of a basic communication environment 10 and a corresponding flow diagram are provided to illustrate initiating multiple calls to different telephony addresses from the originating side of a telephony connection. As illustrated, the communication environment 10 is representative of any type of telecommunication network, such as those supported through packet-based and circuit-switched networks using wired or wireless access connections. Specific examples of the various types of network are provided later in the description, while FIGS. 1 and 2 are provided to illustrate the basic concepts of the present invention. These concepts are applicable in virtually any type of telecommunication network.

At the heart of the communication environment 10 is a core network 12, wherein an originating terminal 14 is supported by an originating node 16, which operates on behalf of the originating terminal 14 to initiate, establish, and control telephony calls involving the originating terminal 14. As will be evident from other examples, the originating node 16 may act as a communication proxy, telephony switch, or the like. Calls initiated through the originating node 16 for the originating terminal 14 may be directed to any number of terminating terminals 18 (A, B, and C) through one or more terminating nodes 20 (A, B, and C), which again may act as proxies or terminating switches for the terminating terminals 18.

For the present invention, a user may initiate a multiple call (multi-call) event by dialing digits including or corresponding to multi-call indicia, which may correspond to a code, alphanumeric sequence, or the like, which can be processed by the originating node 16 to detect the multi-call indicia for the multi-call event (step 100 of FIG. 2). The originating node 16 will identify multiple destinations based on the multi-call indicia (step 102) and initiate multiple calls to the multiple destinations in a simultaneous or sequential fashion (step 104). The originating node 16 may store a list of telephony addresses, such as directory numbers or uniform resource locators (URLs) or identifiers (URIs), which represent the multiple destinations. The multiple telephony addresses or destinations will correspond to the multi-call indicia provided from the originating terminal 14 to initiate the multi-call event.

Whether simultaneous or sequential call initiation is used may be based on information stored in association with the multi-call indicia, or may be based on information provided in the multi-call indicia. As such, the originating node 16 may be preconfigured to use simultaneous or sequential call initiation upon receiving the multi-call indicia or dynamically determine whether to use simultaneous or sequential call initiation based on the multi-call indicia.

For simultaneous call initiation, the originating node 16 will initiate calls substantially simultaneously by sending call initiations toward the terminating terminals 18 (A, B, and C) or the terminating nodes 20 (A, B, and C) supporting the terminating terminals 18. In this instance, assume that the multi-call indicia is associated with destinations corresponding to the terminating terminals 18 (A, B, and C). As such, the call initiation messages (A, B, and C) are sent substantially simultaneously to each of the terminating nodes 20 (A, B, and C), which will respond by attempting to establish the call with the respective terminating terminals 18 (A, B, and C). During this process, the terminating terminals 18 (A, B, and C) will provide alerts, such as initiating ringing. As such, the terminating terminals 18 (A, B, and C) will ring at substantially the same time. For the first one of the terminating terminals 18 (A, B, and C) to be answered, a message (not shown) will be directed to the originating node 16 indicating the same. Upon receipt of the message, the originating node 16 will detect that one of the terminating terminals 18 (A, B, or C) was answered (step 106) and will take the necessary steps to establish a telephony connection for the call between the originating terminal 14 and the terminating terminal that was answered (18C in this example) (step 108).

In the illustrated embodiment, terminating terminal 18C was answered, and thus, the telephony connection for the call is established between the originating terminal 14 and terminating terminal 18C. Also in the illustrated embodiment, the telephony connection for the call is supported through the originating node 16 and the terminating node 20C. However, those skilled in the art will recognize that the telephony connection for the call may be established between the originating terminal 14 and the terminating terminal 18C outside of the originating node 16 and the terminating node 20C. When one of the terminating terminals 18 (A, B, or C) is answered and a telephony connection for the call is established, the other call initiation attempts are stopped (step 110).

For a multi-call event where sequential call initiation attempts are made to the identified destinations, the following process may be used. Initially, the originating node 16 may initiate a call to terminating terminal 18A, and if terminating terminal 18A is not answered within a set amount of time or number of rings, the call initiation attempt to terminating terminal 18A is stopped and a call initiation attempt is then made to terminating terminal 18B. If terminating terminal 18B is not answered within a certain amount of time or number of rings, the call initiation attempt is stopped, and a new call initiation attempt is made to terminating terminal 18C. If terminating terminal 18C is answered, the telephony connection for the call is established between the originating terminal 14 and the terminating terminal 18C, as illustrated. In essence, once one of the terminating terminals 18 that is identified as a destination in the multi-call event is answered, the process may stop, wherein further call initiation attempts are not provided. In the present example, if terminating terminal 18B was answered, the telephony connection for the call would be established between the originating terminal 14 and terminating terminal 18B, and the call initiation for terminating terminal 18C would not be provided.

One of the benefits of the present invention is that the originating party can associate multiple destinations for another party, and associate unique multi-call indicia with the collection of destinations. Upon providing the multi-call indicia to the originating node 16, multiple call attempts may be initiated to the various destinations in sequence or simultaneously, wherein the first terminating terminal 18 answered will be the one with which a telephony connection for the call is established. As such, the originating party can control the destinations to use for the multi-call event, and avoid having to manually attempt separate calls to each of the various destinations until the called party answers.

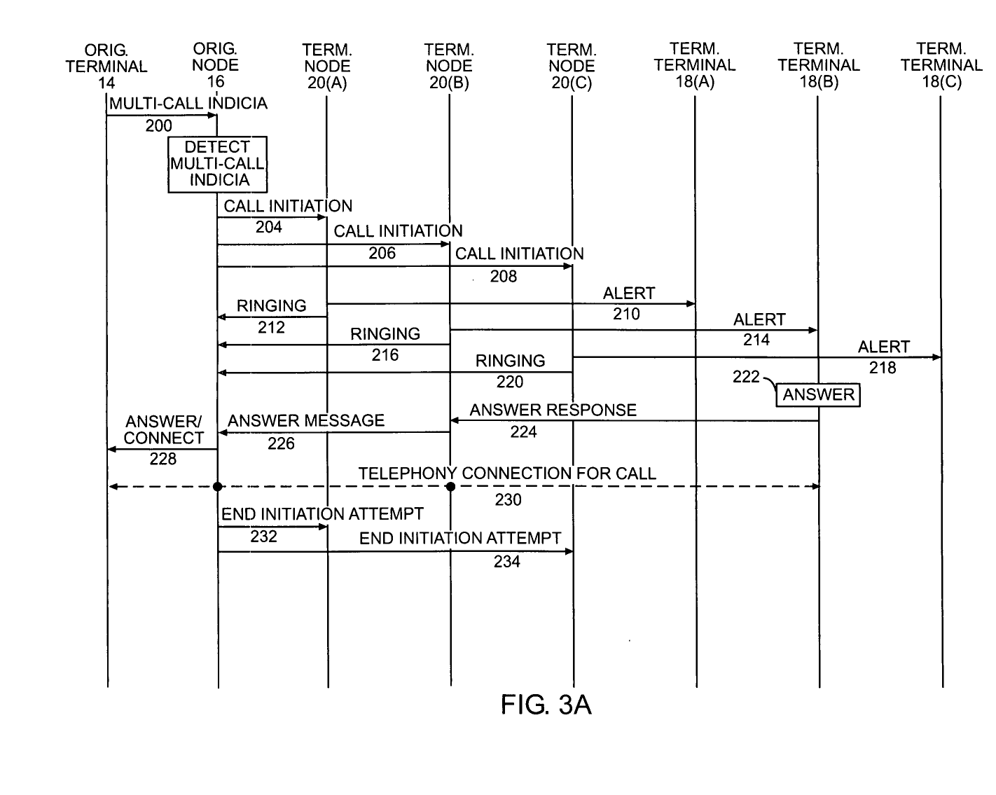

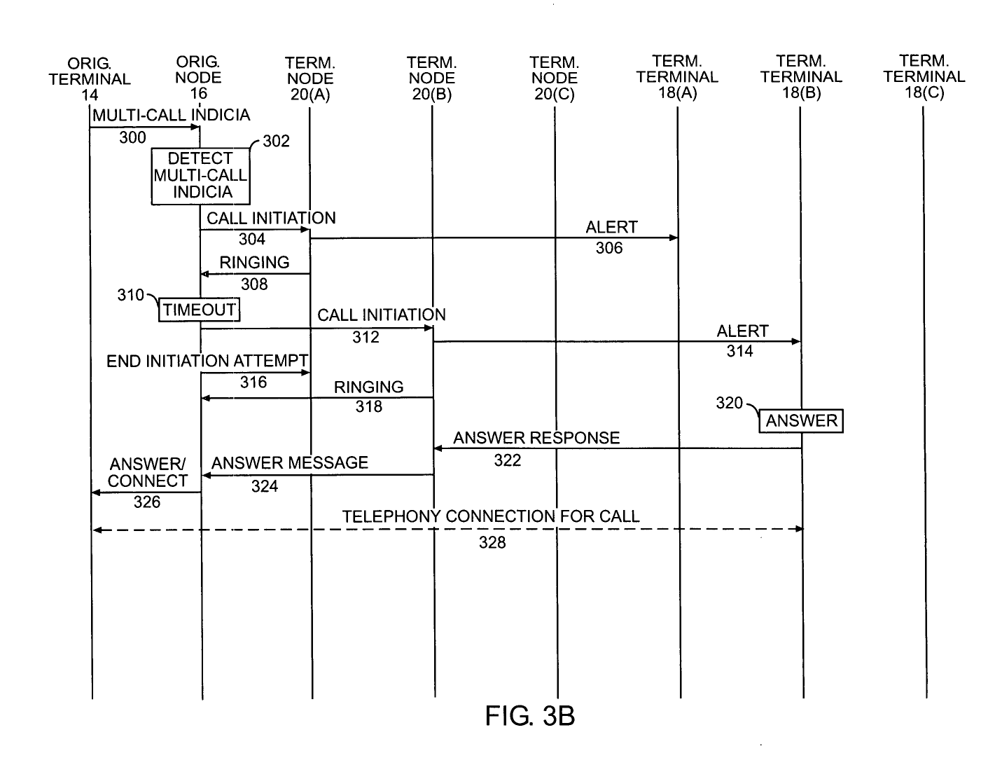

For further clarification, FIGS. 3A and 3B provide communication flows using pseudo messaging to illustrate simultaneous and sequential call initiation in response to recognizing a multi-call event, respectively. With particular reference to FIG. 3A, a user may dial select multi-call indicia corresponding to a predefined group of destinations, and the originating terminal 14 will provide the multi-call indicia to the originating node 16, perhaps as if it were a normal call initiation or dialing of a special feature code (step 200). The originating node 16 will detect the multi-call indicia and identify the destinations associated therewith. Again, assume the destinations correspond to terminating terminals 18 (A, B, and C). For simultaneous multi-call initiation, the originating node 16 will substantially simultaneously send Call Initiation messages to terminating nodes 20 (A, B, and C) (steps 204, 206, and 208). Upon receipt of the call initiation messages, the terminating nodes 20 (A, B, and C) will initiate alerting by sending Alert messages to the corresponding terminating terminals 18 (A, B, and C) (steps 210, 214, and 218) as well as providing a Ringing indication back to the originating node 16 (steps 212, 216, and 220) for the respective terminating terminals 18 (A, B, and C). The originating node 16 may provide a Ringing indication to the originating terminal 14 (not shown) to inform the user that the call initiation attempts are being made.

At this time, each of the terminating terminals 18 (A, B, and C) will be ringing or otherwise providing alerts to indicate that an incoming call is being attempted in traditional fashion. In this example, assume that terminating terminal 18B is answered by the called party (step 222). When the terminating terminal 18B is answered, the terminating node 20B will detect that terminating terminal 18B has been answered or receiving an Answer Response from the terminating terminal 18B (step 224) and then provide an Answer Message to the originating node 16 (step 226). Depending on the communication environment, the originating node 16 may send an Answer or Connect message to the originating terminal 14 (step 228), wherein a telephony connection for the call is established between the originating terminal 14 and the terminating terminal 18B, perhaps through the originating node 16 and terminating node 20B (step 230). Either during or after establishment of the telephony connection for the call, the originating node 16 will send messages to end the call initiation attempts for terminating terminals 18A and 18C to terminating nodes 20A and 20C (steps 232 and 234). At this point, the telephony connection for the call is established and the alerting for terminating terminals 18A and 18C is stopped.

With reference to FIG. 3B, a sequential multi-call initiation communication flow is provided. The originating terminal 14 will send multi-call indicia to the originating node 16 in response to the user triggering a multi-call event (step 300). The originating node 16 will detect the multi-call indicia and identify the multiple destinations to which sequential call initiation attempts should be made until the call is answered (step 302). Again, the originating node 16 may be preconfigured to provide sequential call initiations in a defined order for each of the destinations, or the multi-call indicia may include such information. In this example, assume the originating node 16 is configured to initiate a first call to terminating terminal 18A, and if not answered after a certain period of time, initiate a second call to terminating terminal 18B. If terminating terminal 18B is not answered after a certain period of time, the originating node 16 will initiate a third call to terminating terminal 18C. Accordingly, the originating node 16 will send a Call Initiation message to terminating node 20A (step 304), which will trigger alerting at terminating terminal 18A (step 306). Terminating node 20A may provide a Ringing indication to the originating node 16 while alerting is proceeding at the terminating terminal 18A (step 308). The originating node 16 may initiate a timer. If the timer times out before the call to terminating terminal 18A is answered (step 310), the originating node 16 will initiate a call to terminating terminal 18B by sending a Call Initiation message to terminating node 20B (step 312), which will effect alerting at terminating terminal 18B (step 314).

Meanwhile, the originating node 16 may end the call initiation attempt to terminating terminal 18A by sending an appropriate message to terminating node 20A (step 316). The terminating node 20B will provide a Ringing indication to the originating node 16 to indicate that terminating terminal 18B is providing an alert for the call (step 318). The originating node 16 may initiate a timer and wait for a timeout. If terminating terminal 18B is answered (step 320), the terminating node 20B will recognize that terminating terminal 18B has been answered, or receive an Answer Response from terminating terminal 18B (step 322). Terminating node 20B will then send an Answer Message back to the originating node 16 (step 324), which may provide an Answer or Connect message to the originating terminal 14, depending on the communication environment (step 326). At this point, a telephony connection for the call is established between the originating terminal 14 and terminating terminal 18B (step 328). Notably, the originating node 16 will not proceed with a call initiation attempt to terminating terminal 18C, since terminating terminal 18B was answered.

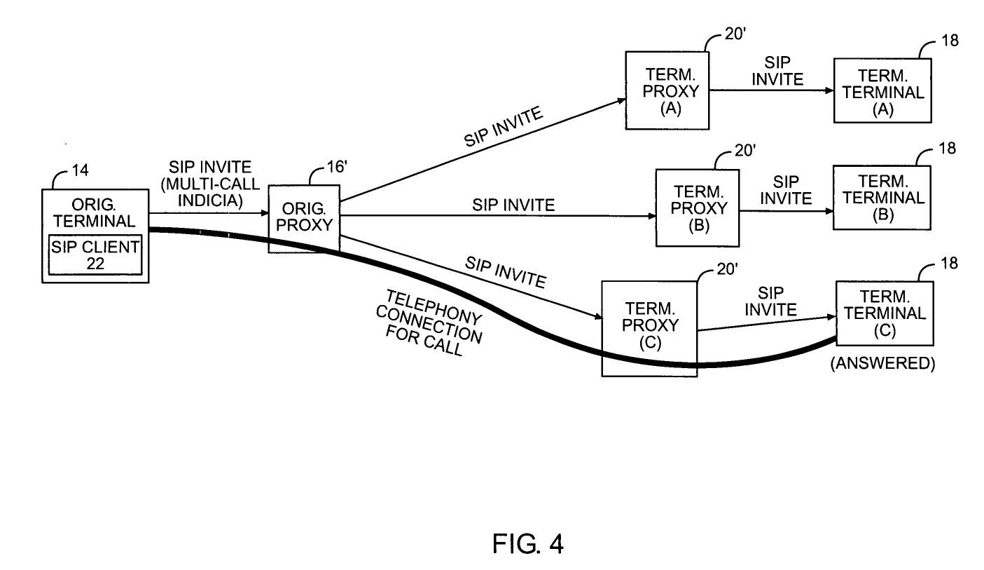

The concepts of the present invention are applicable to various types of communication environments. With reference to FIG. 4, the concepts of multi-call origination are implemented in a packet-based communication environment using the Session Initiation Protocol (SIP). Those skilled in the art will recognize that any type of session control protocol may be used to support multi-call origination. In this embodiment, the originating terminal 14 supports a SIP client 22, which handles telephony communications with various SIP entities. The originating node 16 is represented as an originating proxy 16′ and the terminating nodes 20 are terminating proxies 20′ (A, B, and C), respectively. To initiate a multi-call event, a user may instruct the SIP client 22 to dial a certain number or provide a certain feature code corresponding to a multi-call event. The SIP client 22 need not recognize that the dialed digits or the code actually correspond to the multi-call event, but will simply respond to user input and attempt to initiate a call by sending a SIP Invite message with the multi-call indicia to the originating proxy 16′.

The originating proxy 16′ will identify multiple destinations based on the multi-call indicia, and initiate multiple calls to the multiple destinations by sending corresponding SIP Invite messages to the respective terminating proxies 20′ (A, B, and C) in an effort to establish calls in a sequential or simultaneous fashion with the terminating terminals 18 (A, B, and C). The terminating proxies 20′ (A, B, and C) will forward the SIP Invite messages to the terminating terminals 18 (A, B, and C) to further call initiation. The terminating terminals 18 (A, B, and C) will provide alerts, and when one of the terminating terminals 18C is answered, a telephony connection for the call will be established between the SIP client 22 of the originating terminal 14 and the answered terminating terminal 18C. If simultaneous call initiation attempts were provided, the originating proxy 16′ may take the necessary steps to stop call initiation to the unanswered terminating terminals 18A and 18B.

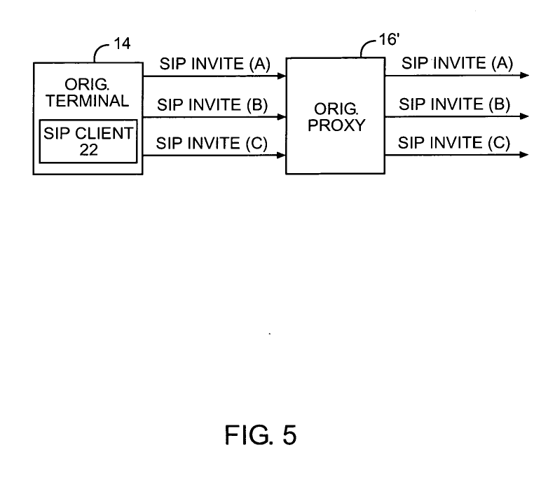

With reference to FIG. 5, the multi-call functionality described above may be provided in the originating terminal 14 instead of at the originating node 16. In a SIP environment, the SIP client 22 may support the multi-call functionality, and thus recognize a user entering digits or a code corresponding to a multi-call event. Upon detecting the multi-call event, the multi-call indicia provided by the user is used to identify multiple destinations to which to initiate calls. As such, the originating terminal 14 may send separate SIP Invite messages in a sequential or simultaneous fashion toward the respective terminating terminals 18 (A, B, and C), directly or indirectly via the terminating proxies 20′ (not shown in FIG. 5). Although illustrated in a SIP environment, multi-call functionality may be implemented in the originating terminal 14 in any type of communication environment.

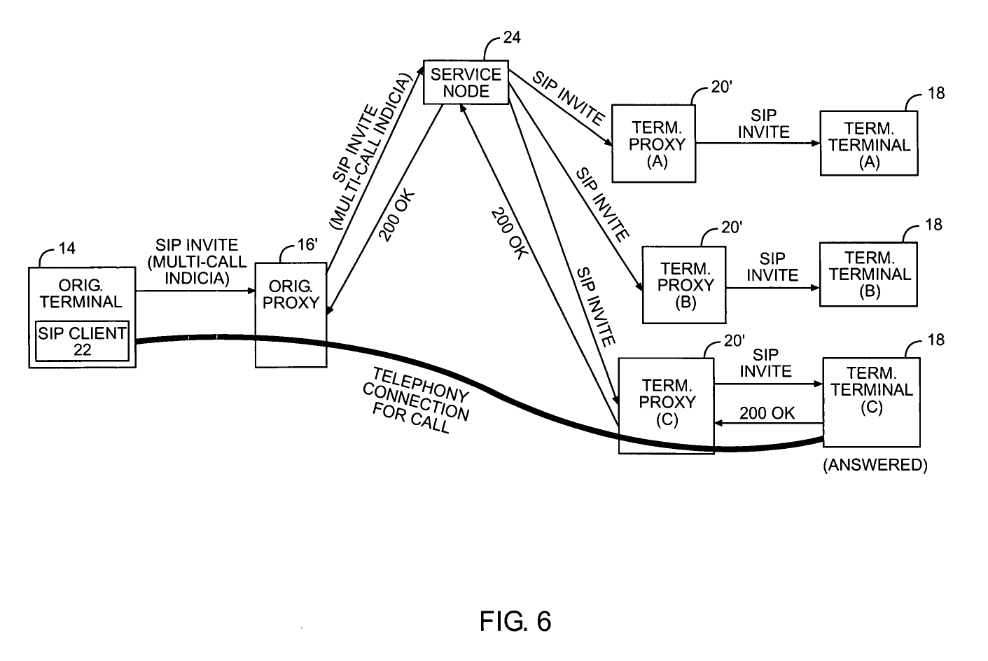

With reference to FIG. 6, the multi-call functionality may also be implemented in a service node 24, which is separate from the respective originating terminal 14 or originating node 16. In FIG. 6, the originating proxy 16′ will forward a SIP Invite message including the multi-call indicia to the service node 24. The service node 24 will recognize the multi-call indicia, identify the destinations associated with the multi-call indicia, and send SIP Invite messages toward terminating proxies 20′ (A, B, and C) in a sequential or simultaneous fashion to initiate call attempts to the terminating terminals 18 (A, B, and C). If terminating terminal 18C is answered, a 200 OK message is provided to the terminating proxy 20′ (C), and the message is then forwarded to the SIP client 22 of the originating terminal 14 via the service node 24 and the originating proxy 16′, wherein a telephony connection for the call is established between the originating terminal 14 and the terminating terminal 18C, directly or indirectly via the originating proxy 16′ and the terminating proxy 20′ (C).

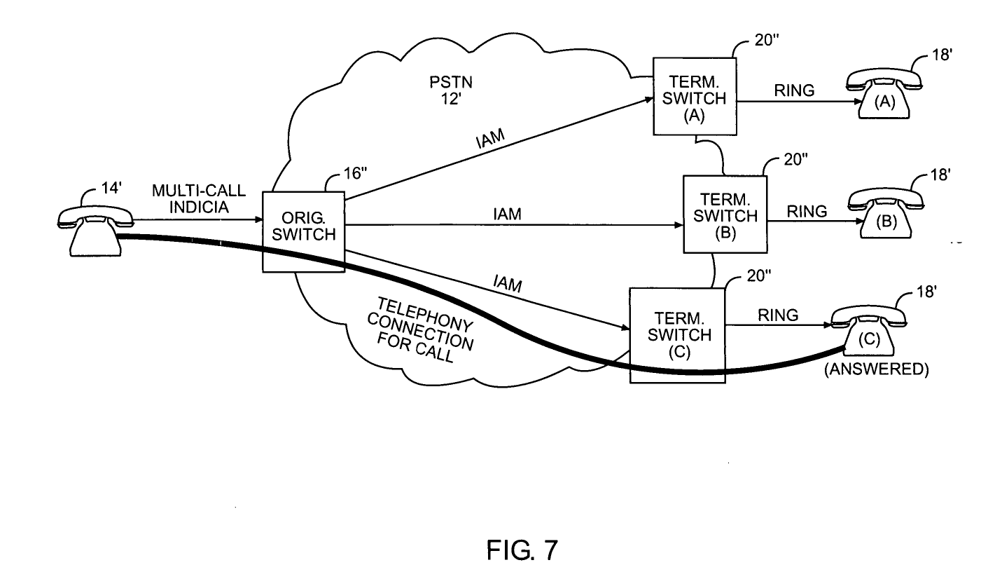

FIG. 7 illustrates multi-call origination in a public switched telephone network (PSTN) 12′. In this embodiment, an originating switch 16″ will receive dual tone multi-frequency (DTMF) digits corresponding to the multi-call indicia from an originating telephone terminal 14′. The originating switch 16″ will recognize the multi-call indicia and identify corresponding destinations for the multi-call indicia. The originating switch 16″ will then initiate calls to the terminating terminals 18′ (A, B, and C) corresponding to the destinations in a sequential or simultaneous fashion. Call initiation may be started using an Integrated Services User Part (ISUP) Initial Address Message (IAM), which is sent to each of the terminating switches 20″ (A, B, and C). The destinations associated with the multi-call indicia may be a list of directory numbers that are used in the ISUP IAM messages, which are routed to the appropriate terminating switch 20″ based on these directory numbers. Upon receipt of the ISUP IAMS, the terminating switches 20″ will initiate ringing of their respective terminating terminals 18′. If terminating terminal 18′ (C) is answered, the originating switch 16″ and the terminating switch 20″ (C) will cooperate with each other and any other switches along the bearer path throughout the PSTN 12′ to establish a telephony connection for the call in traditional fashion. The originating switch 16″ will take the requisite steps to stop call initiation to the unanswered terminating terminals 18′ (A and B).

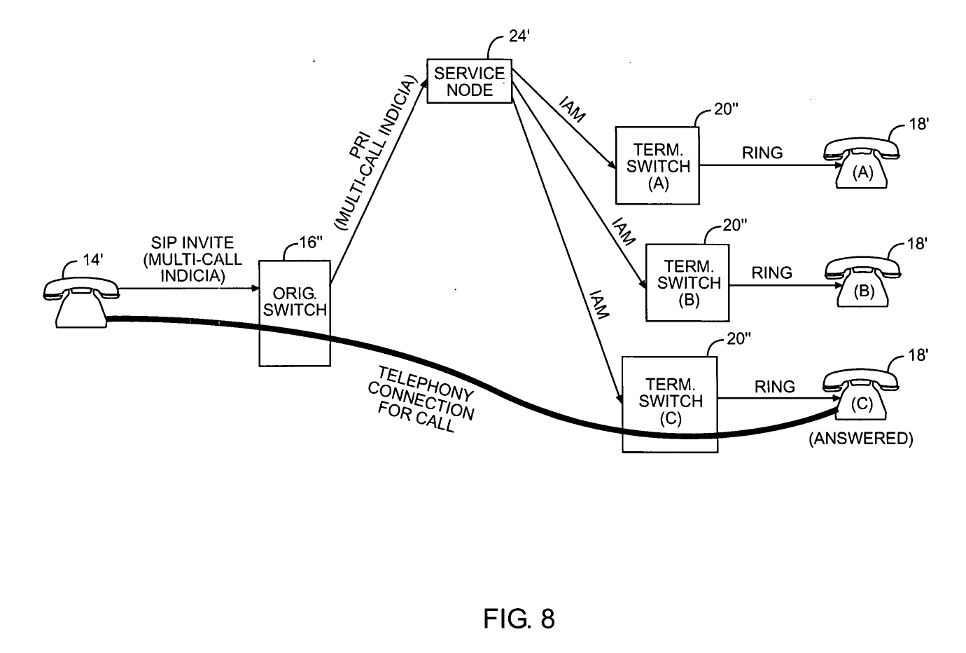

As illustrated in FIG. 8, a service node 24 associated with the PSTN 12′ (as illustrated in FIG. 7) is used to support the multi-call origination. The service node 24′ will be associated closely with the originating switch 16″ to provide call control and related signaling. As such, digits dialed by the user at the originating terminal 14′ are passed as multi-call indicia to the originating switch 16″, which will forward the multi-call indicia to the service node 24′ through a primary rate interface (PRI) or like connection. The service node 24′ will recognize the multi-call indicia and identify the destinations associated with the multi-call indicia. The service node 24′ will then attempt to initiate calls to the respective destinations in a sequential or simultaneous fashion. As such, ISUP IAMs may be provided in sequence or simultaneously to the terminating switches 20″ (A, B, and C), which will cause the terminating terminals 18′ to ring. When terminating terminal 18′ (C) is answered, the terminating switch 20″ (C), originating switch 16″, and the service node 24′ will cooperate to establish a telephony connection for the call between the originating terminal 14′ and the terminating terminal 18′ (C).

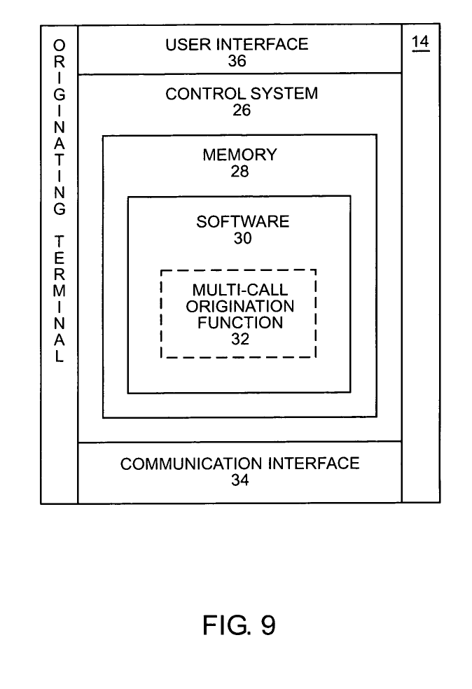

With reference to FIG. 9, a block representation of an originating terminal 14 is illustrated. The originating terminal 14 will include a control system 26 having memory 28 for any software 30 required for operation. The software 30 may include a multi-call origination function 32 when such functionality is provided in the originating terminal 14. The control system 26 may also be associated with a communication interface 34 to facilitate interaction with an appropriate access network to support telephony connections and interactions with an originating node 16 if necessary. The control system 26 will also be associated with a user interface 36 to receive user input, provide information to a user, and support bidirectional voice communications with the user.

When the multi-call origination function 32 is supported by the originating terminal 14, user input, such as dialed digits or other instructions from the user may represent multi-call indicia, which is stored in association with multiple destinations to which calls are initiated when the multi-call indicia is received from the user. As configured, the originating terminal 14 may support initiation of multiple calls and establish a telephony connection for a call to the terminating terminal 18 that is answered in response to initiation of the multiple calls. The configuration of the originating terminal 14 may range from a traditional analog telephone to a packet-based telephone, personal computer, or personal digital assistant with telephony capability.

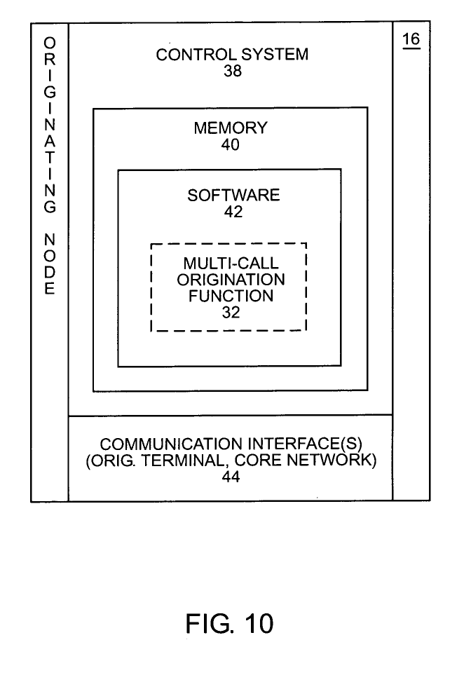

An originating node 16 is illustrated in FIG. 10. The originating node 16 will have a control system 38 with sufficient memory 40 for the software 42 required to operate as described above. A multi-call origination function 32 may be provided in the software 42 to impart multi-call functionality to the originating node 16. The control system 38 will be associated with one or more communication interfaces 44 to facilitate communications with the originating terminal 14 as well as with various devices via the core network 12.

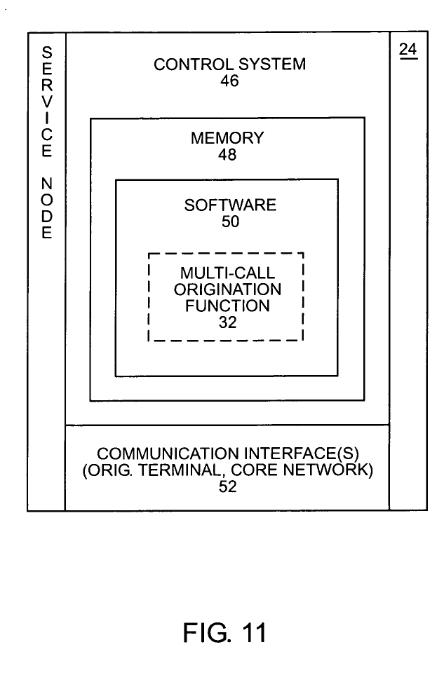

A block representation of a service node 24 is provided in FIG. 11. The service node 24 will include a control system 46 having sufficient memory 48 for the requisite software 50 to operate as described above. The software 50 may include a multi-call origination function 32 to impart multi-call origination functionality to the service node 24. The control system 46 will be associated with one or more communication interfaces 52 to facilitate communications over the core network 12. For the present invention, the service node 24 is affiliated with the originating terminal 14 or the originating node 16.

Those skilled in the art will recognize improvements and modifications to the preferred embodiments of the present invention. All such improvements and modifications are considered within the scope of the concepts disclosed herein and the claims that follow.

What is claimed is:

1. A method of originating multiple calls to multiple destinations from an originating entity comprising:
detecting multiple call indicia for a multiple call event initiated by a user;
identifying a plurality of destinations based on the multiple call indicia;
initiating a plurality of calls to at least two of the plurality of destinations; and
effecting establishment of a telephony connection for a call to a first destination of the at least two of the plurality of destinations, which is first to be answered.

2. The method of claim 1 wherein the plurality of calls to the at least two of the plurality of destinations are initiated substantially simultaneously.

3. The method of claim 2 further comprising halting call initiation attempts to at least two of the plurality of destinations that are not answered after the first destination is answered.

4. The method of claim 1 wherein the plurality of calls to the at least two of the plurality of destinations are initiated in succession.

5. The method of claim 4 wherein when a call initiation attempt to one destination is unanswered, another call initiation attempt to another destination is initiated until a call initiation attempt is answered.

6. The method of claim 1 wherein detecting the multiple call indicia comprises receiving the multiple call indicia from an associated originating terminal, such that the steps of detecting, identifying, initiating, and effecting are provided at an originating node supporting the originating terminal.

7. The method of claim 1 wherein detecting the multiple call indicia comprises receiving the multiple call indicia from an associated user interface and further comprising establishing the telephony connection for the call with the destination, such that the steps of detecting, identifying, initiating, and effecting are provided at an originating terminal.

8. The method of claim 1 wherein detecting the multiple call indicia comprises receiving the multiple call indicia from an associated originating terminal, such that the steps of detecting, identifying, initiating, and effecting are provided by a service node adapted to control an originating node supporting the originating terminal.

9. The method of claim 1 wherein the multiple call indicia comprises a dialed string of digits corresponding to the plurality of destinations.

10. The method of claim 1 wherein the telephony connection is established at least in part over a public switched telephone network.

11. The method of claim 1 wherein the telephony connection is established at least in part over a packet network.

12. An originating entity facilitating origination of multiple calls to multiple destinations comprising:
at least one communication interface; and
a control system associated with the at least one interface and adapted to:
detect multiple call indicia for a multiple call event initiated by a user;
identify a plurality of destinations based on the multiple call indicia;
initiate a plurality of calls to at least two of the plurality of destinations; and
effect establishment of a telephony connection for a call to a first destination of the at least two of the plurality of destinations, which is first to be answered.

13. The originating entity of claim 12 wherein the plurality of calls to the at least two of the plurality of destinations are initiated substantially simultaneously.

14. The originating entity of claim 13 wherein the control system is further adapted to halt call initiation attempts to at least two of the plurality of destinations that are not answered after the first destination is answered.

15. The originating entity of claim 12 wherein the plurality of calls to the at least two of the plurality of destinations are initiated in succession.

16. The originating entity of claim 15 wherein when a call initiation attempt to one destination is unanswered another call initiation attempt to another destination is initiated until a call initiation attempt is answered.

17. The originating entity of claim 12 wherein the originating entity is an originating node supporting an originating terminal, and to detect the multiple call indicia, the control system is further adapted to receive the multiple call indicia from an associated originating terminal.

18. The originating entity of claim 12 wherein the originating entity is an originating terminal, and to detect the multiple call indicia, the control system is further adapted to receive the multiple call indicia from an integrated user interface.

19. The originating entity of claim 12 wherein the originating entity is a service node adapted to control an originating node supporting an originating terminal, and to detect the multiple call indicia, the control system is further adapted to receive the multiple call indicia from the originating terminal.

20. The originating entity of claim 12 wherein the multiple call indicia comprises a dialed string of digits corresponding to the plurality of destinations.

21. The originating entity of claim 12 wherein the telephony connection is established at least in part over a public switched telephone network.

22. The originating entity of claim 12 wherein the telephony connection is established at least in part over a packet network.
